(19) United States
(12) Patent Application Publication
(10) Pub. No.: US 2026/0129291 A1
(43) Pub. Date: May 7, 2026

(54) IMAGING APPARATUS, OPERATION METHOD OF IMAGING APPARATUS, AND OPERATION PROGRAM OF IMAGING APPARATUS

(71) Applicant: FUJIFILM Corporation, Tokyo (JP)

(72) Inventor: Hinako SUZUKI, Saitama (JP)

(73) Assignee: FUJIFILM Corporation, Tokyo (JP)

(21) Appl. No.: 19/377,024

(22) Filed: Nov. 2, 2025

(30) Foreign Application Priority Data
Nov. 5, 2024 (JP) 2024-193623

(51) Int. Cl. H04N 23/67; H04N 23/62; H04N 23/63; H04N 23/667

(52) U.S. Cl. CPC H04N 23/67; H04N 23/62; H04N 23/63; H04N 23/667

(57) ABSTRACT

An imaging apparatus includes a determination unit. The determination unit determines, using a first focal position of a focus lens at a first time point, a second focal position of the focus lens at a second time point after the first time point in continuous imaging. In a case where an imaging preparation instruction is received and a setting condition is satisfied, the determination unit determines the second focal position using the first focal position acquired after the imaging preparation instruction.

### CROSS-REFERENCE TO RELATED APPLICATIONS

The present application claims priority under 35 U.S.C. §119 to Japanese Patent Application No. 2024-193623, filed on November 5, 2024. The above application is hereby expressly incorporated by reference, in its entirety, into the present application.

### BACKGROUND

### 1. Technical Field

The technology of the present disclosure relates to an imaging apparatus, an operation method of an imaging apparatus, and an operation program of an imaging apparatus.

JP2023-009123A discloses an imaging apparatus comprising a processor and an image sensor in which light is focused by an imaging lens including a focus lens, in which the focus lens moves in accordance with an instruction of the processor while avoiding a period of main exposure by the image sensor, and the main exposure is continuously performed by the image sensor at a predetermined time interval to perform continuous imaging. The processor calculates a first focal position of the focus lens with respect to a specific subject based on image data obtained by imaging the specific subject with the main exposure using the image sensor in a specific frame in which the main exposure is performed in a continuous imaging period, and predicts a second focal position of the focus lens with respect to the specific subject in a frame ahead of the specific frame by a plurality of frames with reference to the first focal position for a plurality of frames in the continuous imaging period.

### SUMMARY

One embodiment according to the technology of the present disclosure provides an imaging apparatus, an operation method of an imaging apparatus, and an operation program of an imaging apparatus, with which reliability of a focal position of a focus lens determined in continuous imaging can be improved.

According to the present disclosure, there is provided an imaging apparatus that determines, using information related to a first focal position of a focus lens at a first time point, a second focal position of the focus lens at a second time point after the first time point in continuous imaging, the imaging apparatus comprising: a processor, in which the processor is configured to, in a case where a first imaging instruction is received and a preset condition is satisfied, determine the second focal position using the information related to the first focal position acquired after the first imaging instruction.

It is preferable that the first time point and the second time point in a case where the first imaging instruction is received and the condition is satisfied are after the first imaging instruction.

It is preferable that the processor is configured to, in a case where the first imaging instruction is received and the condition is satisfied, determine the second focal position without using the information related to the first focal position acquired before the first imaging instruction.

It is preferable that the condition is that an interval between the first imaging instruction and a second imaging instruction given after the first imaging instruction is shorter than a preset threshold interval.

It is preferable that the condition is that a difference between a position of the focus lens and the first focal position before the first imaging instruction is equal to or greater than a preset threshold difference.

It is preferable that the processor is configured to perform a live view image output process of outputting a live view image of a subject, in which information related to at least the first focal position is derived but the focus lens is not moved to the second focal position, and that the difference is a difference between the position of the focus lens and the first focal position in the live view image output process immediately before the first imaging instruction is issued.

It is preferable that the processor is configured to, in a case where an interval between the first imaging instruction and a second imaging instruction given after the first imaging instruction is equal to or longer than a preset threshold interval, determine the second focal position using the information related to the first focal position acquired before the first imaging instruction.

It is preferable that the processor is configured to, in a case where a difference between a position of the focus lens and the first focal position before the first imaging instruction is less than a preset threshold difference, determine the second focal position using the information related to the first focal position acquired before the first imaging instruction.

It is preferable that the processor is configured to, in a case where an interval between the first imaging instruction and a second imaging instruction given after the first imaging instruction is equal to or longer than a preset threshold interval and in a case where a difference between a position of the focus lens and the first focal position before the first imaging instruction is less than a preset threshold difference, determine the second focal position using the information related to the first focal position acquired before the first imaging instruction.

It is preferable that the continuous imaging includes a continuous mode in which movement of the focus lens to the second focal position output in time series is continuously performed, and a single mode in which the focus lens is fixed at one second focal position, and that the processor is configured to, in a case where the condition is satisfied in the continuous mode, determine the second focal position using the information related to the first focal position acquired after a second imaging instruction given after the first imaging instruction without using the information related to the first focal position acquired before the first imaging instruction, and, in a case of the single mode, determine the second focal position using the information related to the first focal position acquired before the first imaging instruction.

It is preferable that the continuous imaging includes a release priority mode in which an operation of a release button is prioritized over an in-focus state of the focus lens, and a focus priority mode in which the in-focus state of the focus lens is prioritized over the operation of the release button, and that the processor is configured to, in a case where the condition is satisfied in the release priority mode, determine the second focal position using the information related to the first focal position acquired after a second imaging instruction given after the first imaging instruction without using the information related to the first focal position acquired before the first imaging instruction, and, in a case of the focus priority mode, determine the second focal position using the information related to the first focal position acquired before the first imaging instruction.

It is preferable that the first imaging instruction is an instruction in response to a halfway-press operation of a release button, and that a second imaging instruction given after the first imaging instruction is an instruction in response to a full-press operation of the release button.

According to the present disclosure, there is provided an operation method of an imaging apparatus that determines, using information related to a first focal position of a focus lens at a first time point, a second focal position of the focus lens at a second time point after the first time point in continuous imaging, the operation method comprising: determining the second focal position using the information related to the first focal position acquired after a first imaging instruction, in a case where the first imaging instruction is received and a preset condition is satisfied.

According to the present disclosure, there is provided an operation program of an imaging apparatus that determines, using information related to a first focal position of a focus lens at a first time point, a second focal position of the focus lens at a second time point after the first time point in continuous imaging, the operation program causing a computer to execute a process comprising: determining the second focal position using the information related to the first focal position acquired after a first imaging instruction, in a case where the first imaging instruction is received and a preset condition is satisfied.

### BRIEF DESCRIPTION OF THE DRAWINGS

Exemplary embodiments according to the technique of the present disclosure will be described in detail based on the following figures, wherein:

FIG. 1 is a front view of an imaging apparatus;

FIG. 2 is a rear view of the imaging apparatus;

FIG. 3 is a block diagram showing an electric configuration of the imaging apparatus;

FIG. 4 is a diagram showing an arrangement of pixels of an imaging element;

FIG. 5 is a diagram showing a configuration of a normal pixel;

FIG. 6 is a diagram showing a configuration of a first phase-difference detection pixel;

FIG. 7 is a diagram showing a configuration of a second phase-difference detection pixel;

FIG. 8 is a graph showing a phase difference between a first calculation signal and a second calculation signal;

FIG. 9 is a diagram showing a focus adjustment region;

FIGS. 10A and 10B are diagrams showing calculation data, in which FIG. 10A shows first calculation data and FIG. 10B shows second calculation data;

FIGS. 11A and 11B are diagrams showing two continuous imaging modes, in which FIG. 11A shows a continuous mode and FIG. 11B shows a single mode;

FIGS. 12A and 12B are diagrams showing two continuous imaging modes, in which FIG. 12A shows a release priority mode and FIG. 12B shows a focus priority mode;

FIG. 13 is a diagram showing a live view image output process;

FIG. 14 is a block diagram showing a detailed configuration of a controller;

FIG. 15 is a block diagram showing processing units of a CPU;

FIG. 16 is a diagram showing processing of a determination unit;

FIG. 17 is a diagram showing processing of a derivation unit;

FIG. 18 is a diagram showing a setting condition;

FIGS. 19A and 19B are timing charts showing transitions of derivation of a first focal position, determination of a second focal position, movement of a focus lens, and image output or image recording in a live view image output process, an imaging preparation process, and continuous imaging, in which FIG. 19A shows a case where an interval between a halfway-press operation and a full-press operation of a release button is equal to or longer than a threshold interval, and FIG. 19B shows a case where the interval between the halfway-press operation and the full-press operation of the release button is shorter than the threshold interval;

FIG. 20 is a diagram showing a scene in which a distance between the imaging apparatus and a subject is greatly changed, in which (A) shows a case where a mountain in a distant view is the subject, and (B) shows a case where the subject is switched from the mountain in the distant view to a person in a near view;

FIG. 21 is a flowchart showing a processing procedure in a case where a second focal position is determined by the determination unit;

FIG. 22 is a diagram showing transitions of a first focal position, a second focal position, and a current position of a focus lens in the related art example;

FIG. 23 is a diagram showing transitions of a first focal position, a second focal position, and a current position of a focus lens in the present example;

FIG. 24 is a diagram showing a processing procedure of a focus controller; and

FIG. 25 is a graph showing transitions of the first focal position, the second focal position, and the current position of the focus lens in a case where a hold function is provided.

### DETAILED DESCRIPTION

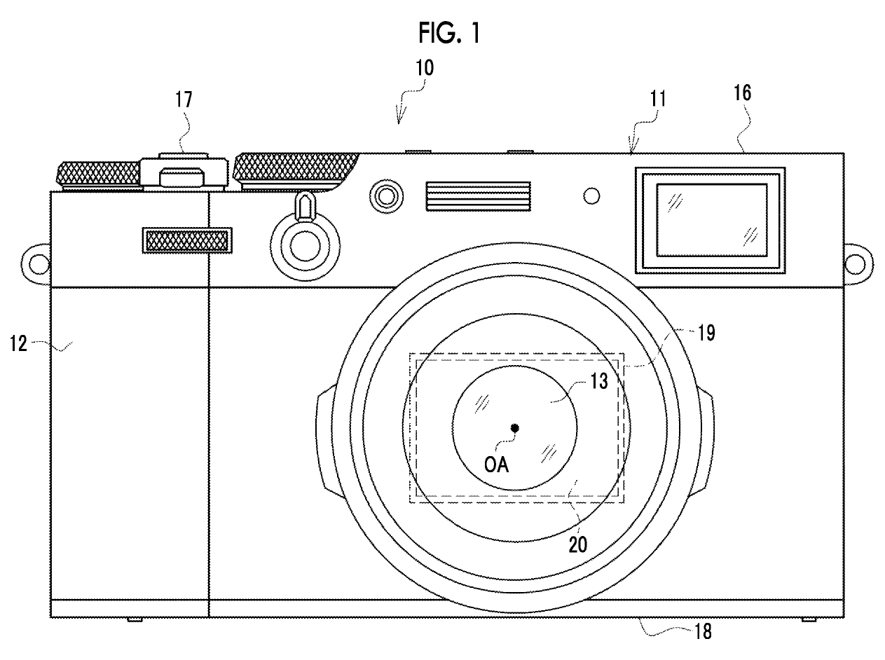

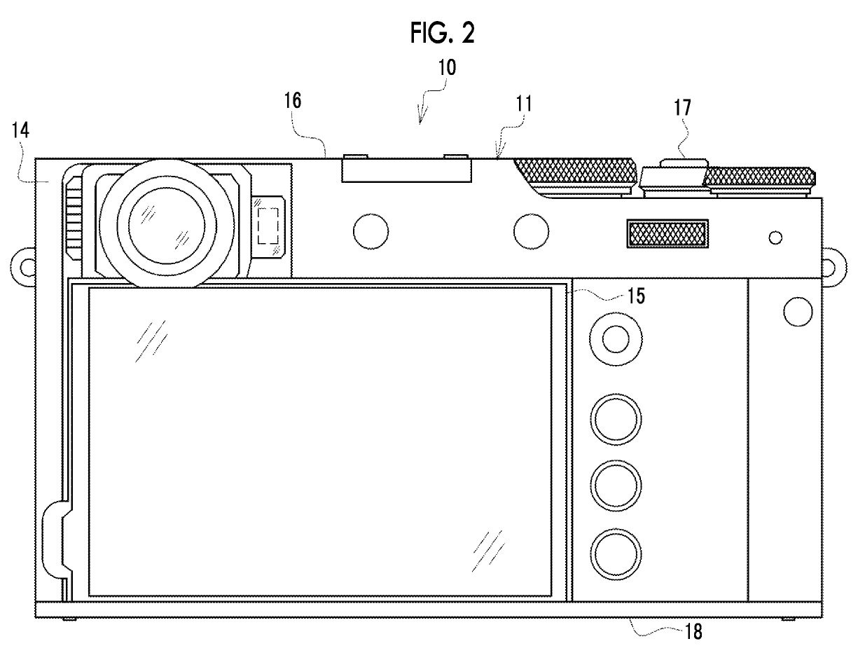

As shown in FIGS. 1 and 2 as an example, an imaging apparatus 10 is, for example, a digital camera, and comprises an apparatus main body 11. An imaging lens 13 and the like are disposed on a front surface 12 of the apparatus main body 11. In addition, a liquid crystal monitor 15 and the like are disposed on a rear surface 14 of the apparatus main body 11 opposite to the front surface 12. Various operation members such as a power switch integrated release button (hereinafter, simply referred to as a release button) 17 are disposed on a top surface 16 of the apparatus main body 11 connecting the front surface 12 and the rear surface 14. A tripod screw hole (not shown) and the like are disposed on a bottom surface 18 of the apparatus main body 11, which is the other surface connecting the front surface 12 and the rear surface 14. The imaging apparatus 10 may be a lens-interchangeable camera in which the imaging lens 13 is interchangeable.

An imaging element 19 is disposed behind the imaging lens 13. The imaging element 19 is, for example, a complementary metal oxide semiconductor (CMOS) image sensor or a charge coupled device (CCD) image sensor. The imaging element 19 has an imaging surface 20 on which subject light is imaged. The imaging element 19 is disposed such that the center of the imaging surface 20 matches an optical axis OA of the imaging lens 13 and the imaging surface 20 is orthogonal to the optical axis OA. The terms “match” and “orthogonal” as used herein mean not only perfect match and orthogonality but also match and orthogonality in a sense including an error generally allowed in the technical field to which the technique of the present disclosure belongs.

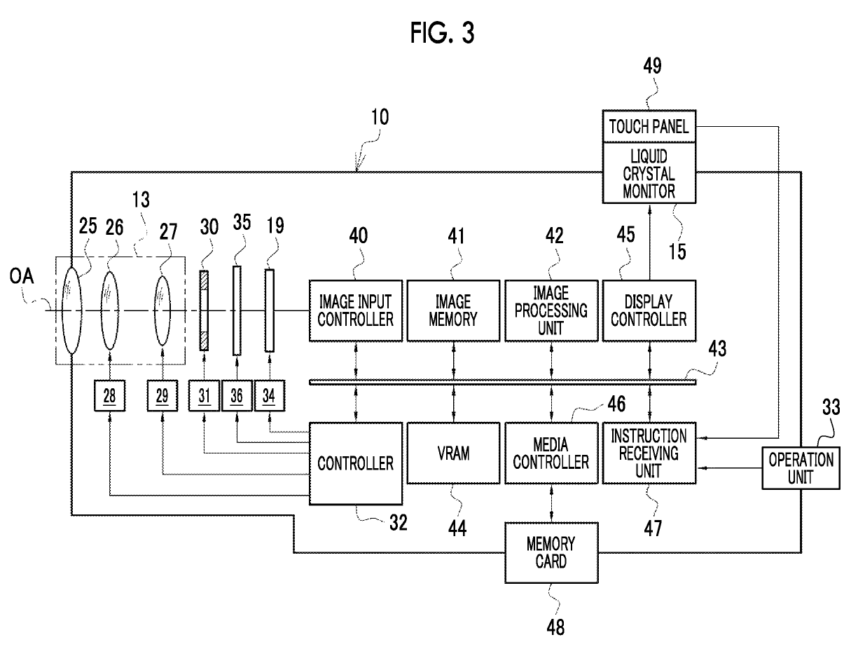

As shown in FIG. 3 as an example, the imaging lens 13 has a plurality of types of lenses for forming a subject image on the imaging element 19. Specifically, the imaging lens 13 has an objective lens 25, a focus lens 26, and a zoom lens 27. These respective lenses 25 to 27 are arranged in this order from an object side (subject side) to an image-forming side (imaging element 19 side). Although simplified in FIG. 3, each of the lenses 25 to 27 is actually a lens group in which a plurality of lenses are combined.

A focus lens driving mechanism 28 is connected to the focus lens 26, and a zoom lens driving mechanism 29 is connected to the zoom lens 27. The focus lens driving mechanism 28 includes a focus cam ring that holds the focus lens 26 and that has a cam groove formed on its outer periphery, a focus motor that rotates the focus cam ring about the optical axis OA to move the focus cam ring along the optical axis OA, a driver of the focus motor, and the like. Similarly, the zoom lens driving mechanism 29 includes a zoom cam ring that holds the zoom lens 27 and that has a cam groove formed on its outer periphery, a zoom motor that rotates the zoom cam ring about the optical axis OA to move the zoom cam ring along the optical axis OA, a driver of the zoom motor, and the like.

A stop 30 is disposed on the image-forming side of the imaging lens 13. The stop 30 is, for example, an iris stop and is formed of a combination of a plurality of stop leaf blades. The stop 30 adjusts the amount of light passing through by simultaneously moving the stop leaf blades using a cam mechanism to open and close a central aperture formed by inner edges of the stop leaf blades, that is, by changing an opening of the aperture. A stop opening adjustment mechanism 31 is connected to the stop 30. The stop opening adjustment mechanism 31 includes a stop motor that opens and closes the stop leaf blades, a driver for the stop motor, and the like.

Various motors such as the focus motor, the zoom motor, and the stop motor are, for example, stepping motors. In this case, a position of the focus lens 26 and a position of the zoom lens 27 on the optical axis OA and the opening of the stop 30 can be derived from drive amounts of the focus motor, the zoom motor, and the stop motor. Instead of using the drive amounts of the focus motor and the zoom motor, a position sensor may be provided to detect the position of the focus lens 26 and the position of the zoom lens 27.

Electric components such as the motor (the focus motor, the zoom motor, and the stop motor) or the driver of each of the driving mechanisms 28, 29, and 31 are connected to a controller 32. The electric components of the driving mechanisms 28, 29, and 31 are driven under the control of the controller 32. More specifically, the controller 32 issues a drive signal in response to an instruction from a user, which is input via an operation unit 33, to drive the electric components of each of the driving mechanisms 28, 29, and 31. For example, in a case where an instruction to change an angle of view to a telephoto side is input via an angle-of-view changing switch included in the operation unit 33, the controller 32 outputs a drive signal to the driver for the zoom motor of the zoom lens driving mechanism 29 to move the zoom lens 27 to the telephoto side.

The operation unit 33 is a general term for a member operated by the user, such as a menu button and a cross key, in addition to a release button 17 described above. Here, the release button 17 is a two-stage push button that can be halfway press-operated and fully press-operated. An imaging preparation instruction to prepare for capturing a still image or a video is issued by the halfway-press operation on the release button 17, and an imaging start instruction to start capturing the still image or the video is issued by the full-press operation of the release button 17. The imaging preparation instruction is an example of a “first imaging instruction” according to the technology of the present disclosure. In addition, the imaging start instruction is an example of a “second imaging instruction” according to the technology of the present disclosure.

The operation unit 33 also includes a mode selector switch for switching an operation mode of the imaging apparatus 10. The operation mode includes a still image capturing mode, a video imaging mode, an image playback mode, a setting mode, and the like. The still image capturing mode includes not only a normal imaging mode in which one still image is captured but also a continuous imaging mode in which still images are continuously captured at a predetermined imaging interval, for example, a frame rate of 5 frames per second (fps) to 10 fps. The continuous imaging mode is activated, for example, in a case where a fully-pressed state of the release button 17 is continued for a predetermined time or longer. The continuous imaging mode ends in a case where the fully-pressed state of the release button 17 is released.

The focus motor, the zoom motor, and the stop motor output the drive amounts to the controller 32. The controller 32 derives the position of the focus lens 26 and the position of the zoom lens 27 on the optical axis OA and the opening of the stop 30 from the drive amounts.

An imaging element driver 34 is connected to the imaging element 19. The imaging element driver 34 is connected to the controller 32. Under the control of the controller 32, the imaging element driver 34 controls a timing at which a subject image is captured by the imaging element 19 by supplying a vertical scanning signal and a horizontal scanning signal to the imaging element 19.

A shutter 35 is disposed between the imaging lens 13 and the imaging element 19. The shutter 35 is, for example, a focal plane shutter including a front curtain and a rear curtain. A shutter driving mechanism 36 is connected to the shutter 35. The shutter driving mechanism 36 includes an electromagnet, a motor, a charge lever, a driver, and the like that hold the front curtain and the rear curtain and release the holding to run the front curtain and the rear curtain. The shutter driving mechanism 36 is driven under the control of the controller 32 to open and close the shutter 35.

The controller 32 is connected to respective units, such as an image input controller 40, an image memory 41, and an image processing unit 42, through a busline 43. In addition, a video random-access memory (VRAM) 44, a display controller 45, a media controller 46, an instruction receiving unit 47, and the like are connected to the busline 43. Although not shown, a strobe drive controller that controls the drive of a strobe device, an external communication interface (I/F) that communicates with an external device via a connection terminal such as a universal serial bus (USB) terminal, a wireless communication I/F that communicates with an external device via a wireless antenna, or the like is also connected to the busline 43.

Image data obtained by imaging the subject light is input to the image input controller 40 from the imaging element 19. The image input controller 40 outputs the image data to the image memory 41. The image memory 41 is, for example, a synchronous dynamic random-access memory (SDRAM), and temporarily stores the image data.

The image processing unit 42 reads out unprocessed image data from the image memory 41. The image processing unit 42 performs various types of image processing on the image data. Examples of the various types of image processing include offset correction processing, sensitivity correction processing, pixel interpolation processing, white balance correction processing, gamma correction processing, demosaicing, generation processing of a brightness signal and a color difference signal, contour enhancement processing, and color correction processing. The image processing unit 42 writes the image data, which has been subjected to the various types of image processing, back to the image memory 41.

The image data, which has been subjected to the various types of image processing and is to be displayed as a live view image, is input to the VRAM 44 from the image memory 41. The VRAM 44 has a region for storing image data for two consecutive frames. The image data stored in the VRAM 44 is sequentially rewritten with new image data. The VRAM 44 sequentially outputs newer image data of the image data for two consecutive frames to the display controller 45.

The display controller 45 functions as a so-called video encoder that converts the image data from the VRAM 44 into video data and that outputs the video data to the liquid crystal monitor 15. As a result, the user can visually recognize the live view image through the liquid crystal monitor 15. A display frame rate of the live view image is, for example, 60 fps.

In a case where an imaging start instruction to start capturing a still image or a video is issued by the full-press operation of the release button 17, the image processing unit 42 performs compression processing on the image data in the image memory 41. In a case of the still image, the image processing unit 42 performs, for example, compression processing of a joint photographic experts group (JPEG) format on the image data. In a case of the video, the image processing unit 42 performs, for example, compression processing of a moving picture experts group (MPEG) format on the image data. The image processing unit 42 outputs the image data, which has been subjected to the compression processing, to the media controller 46.

The media controller 46 records the image data, which has been subjected to the compression processing, from the image processing unit 42 on a memory card 48. The memory card 48 is attachably and detachably mounted in a memory card slot (not shown).

In a case where an image playback mode is selected via a mode selector switch of the operation unit 33, the media controller 46 reads out the image data from the memory card 48 to output the read-out image data to the image processing unit 42. The image processing unit 42 performs expansion processing on the image data from the memory card 48. The image data, which has been subjected to the expansion processing, is output to the display controller 45. The display controller 45 converts the image data into video data and outputs the video data to the liquid crystal monitor 15. Accordingly, the user can visually recognize a playback image through the liquid crystal monitor 15.

The instruction receiving unit 47 receives various operation instructions input from the user via the operation unit 33 and a touch panel 49 integrally provided with the liquid crystal monitor 15. The instruction receiving unit 47 outputs the received various operation instructions to the controller 32 through the busline 43. The touch panel 49 is superimposed on a display surface of the liquid crystal monitor 15. The touch panel 49 detects contact with a finger of the user or a dedicated indicator such as a stylus pen, thereby recognizing the various operation instructions from the user.

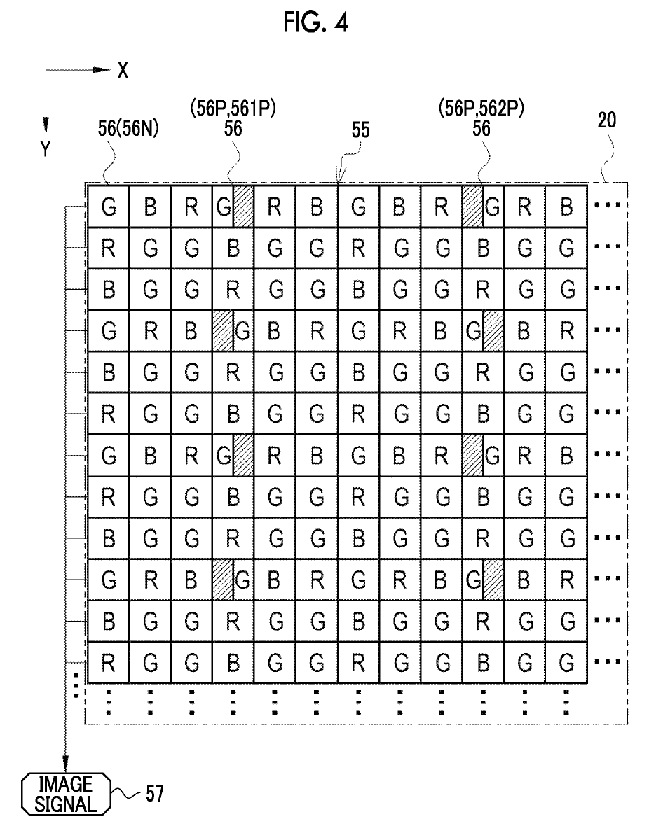

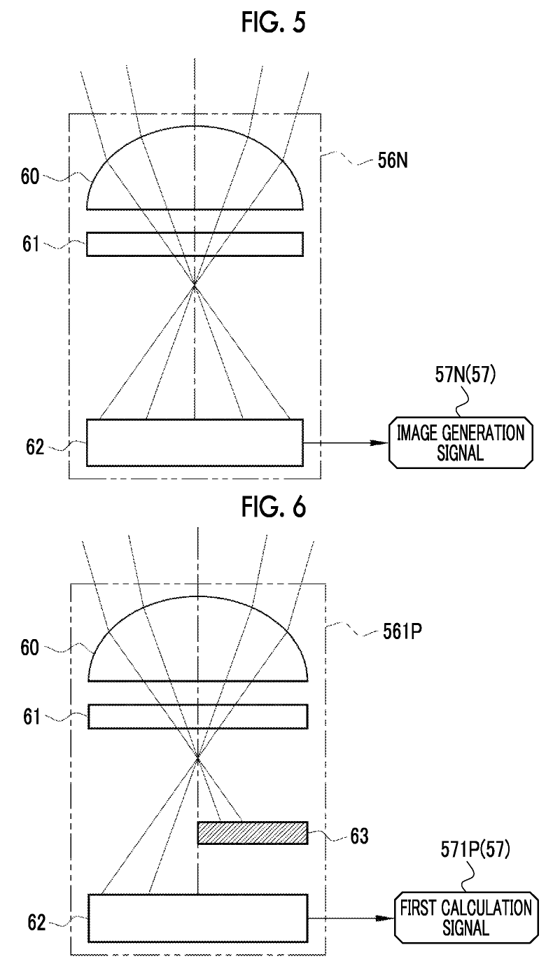

As shown in FIG. 4 as an example, the imaging element 19 is provided with a photoelectric conversion unit 55. The photoelectric conversion unit 55 is composed of a plurality of pixels 56 two-dimensionally arranged along an X direction and a Y direction. The plurality of pixels 56 form the imaging surface 20. As is well known, the pixel 56 is composed of a microlens 60, a color filter 61, and a photoelectric conversion element 62 such as a photodiode (see FIGS. 5 to 7). The X direction and the Y direction are a horizontal direction and a vertical direction in a state in which the bottom surface 18 of the imaging apparatus 10 is placed on a horizontal plane.

Scanning lines parallel to the X direction are wired between rows of the pixels 56. In addition, signal lines parallel to the Y direction are wired between columns of the pixels 56. The pixel 56 (photoelectric conversion element 62 thereof) is connected to the signal line via an amplifier and a switch. The scanning line is also connected to the switch. In a case of an accumulation operation in which a signal charge corresponding to the subject light is accumulated in the pixel 56 (photoelectric conversion element 62 thereof), an OFF signal is supplied as a vertical scanning signal through the scanning line to turn off the switch. In a case of a readout operation in which an image signal (voltage signal) 57 corresponding to the signal charge is read out from the pixel 56 (photoelectric conversion element 62 thereof), an ON signal is supplied as a vertical scanning signal through the scanning line to turn on the switch. A terminal of the signal line is connected to a correlated double sampling (CDS) circuit and an analog-to-digital converter (ADC) circuit. The CDS circuit performs correlated double sampling on the image signal 57 input through the signal line. The ADC circuit converts the image signal 57 after the correlated double sampling into a digital image signal 57.

The pixels 56 are divided, depending on a type of the color filter 61, into three types of a green pixel (denoted by “G” in FIG. 4) having sensitivity to light in a green wavelength range, a red pixel (denoted by “R” in FIG. 4) having sensitivity to light in a red wavelength range, and a blue pixel (denoted by “B” in FIG. 4) having sensitivity to light in a blue wavelength range. The three types of the pixels 56 are regularly arranged in a predetermined array. As the predetermined array, a so-called Bayer array is described here, in which two green pixels, one blue pixel, and one red pixel are arranged in vertical and horizontal 2 × 2 pixels.

The pixels 56 include a normal pixel 56N and a phase-difference detection pixel 56P. The phase-difference detection pixels 56P further include a first phase-difference detection pixel 561P and a second phase-difference detection pixel 562P. The normal pixels 56N are of three types: a green pixel; a blue pixel; and a red pixel, but the phase-difference detection pixels 56P are only green pixels.

The phase-difference detection pixels 56P are arranged at predetermined intervals in the X direction and the Y direction. In FIG. 4, the phase-difference detection pixels 56P are arranged at an interval of five pixels in the X direction and at an interval of two pixels in the Y direction. In addition, as the phase-difference detection pixels 56P, the first phase-difference detection pixel 561P and the second phase-difference detection pixel 562P are arranged to alternately appear in the X direction and the Y direction. For example, in a case of a fourth row, the phase-difference detection pixels 56P are arranged, from left to right, in an order of the second phase-difference detection pixel 562P, the first phase-difference detection pixel 561P, and the like. In addition, for example, in a case of a tenth column, the phase-difference detection pixels 56P are arranged, from top to bottom, in an order of the second phase-difference detection pixel 562P, the first phase-difference detection pixel 561P, the second phase-difference detection pixel 562P, the first phase-difference detection pixel 561P, and the like. The first phase-difference detection pixel 561P and the second phase-difference detection pixel 562P adjacent to each other in the X direction and the Y direction constitute one set for detecting a phase difference α (see FIG. 8).

As shown in FIGS. 5 to 7 as an example, the normal pixel 56N, the first phase-difference detection pixel 561P, and the second phase-difference detection pixel 562P have the same basic configuration. That is, the normal pixel 56N, the first phase-difference detection pixel 561P, and the second phase-difference detection pixel 562P are each composed of the microlens 60, the color filter 61, and the photoelectric conversion element 62 arranged in order from the object side.

As shown in FIG. 5, the photoelectric conversion element 62 of the normal pixel 56N outputs, as the image signal 57, an image generation signal 57N corresponding to the subject light that is condensed by the microlens 60 and transmitted through the color filter 61. The image generation signal 57N is stored in the image memory 41 as a part of the image data.

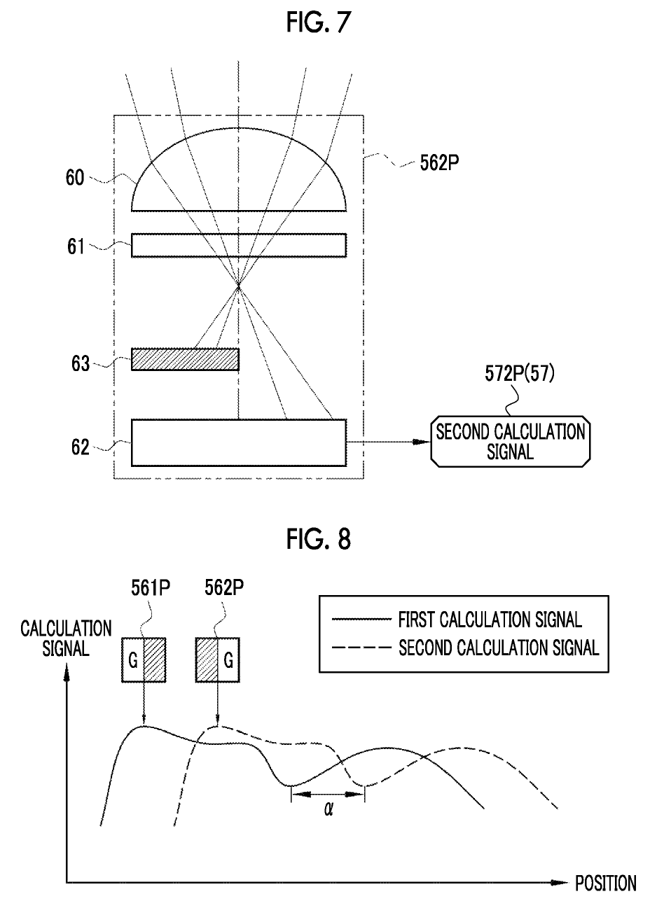

As shown in FIGS. 6 and 7, a light shielding member 63 is disposed between the color filter 61 and the photoelectric conversion element 62 of the first phase-difference detection pixel 561P and the second phase-difference detection pixel 562P. The light shielding member 63 is not disposed in the normal pixel 56N. The light shielding member 63 of the first phase-difference detection pixel 561P shields a right half of the photoelectric conversion element 62, as viewed from the object side. With respect to this, the light shielding member 63 of the second phase-difference detection pixel 562P shields a left half of the photoelectric conversion element 62, as viewed from the object side.

The photoelectric conversion element 62 of the first phase-difference detection pixel 561P outputs, as the image signal 57, a first calculation signal 571P corresponding to the subject light that is condensed by the microlens 60 and transmitted through the color filter 61 and that has the right half shielded by the light shielding member 63. With respect to this, the photoelectric conversion element 62 of the second phase-difference detection pixel 562P outputs, as the image signal 57, a second calculation signal 572P corresponding to the subject light that is condensed by the microlens 60 and transmitted through the color filter 61 and that has the left half shielded by the light shielding member 63. The first calculation signal 571P and the second calculation signal 572P are stored in the image memory 41 as a part of the image data, as with the image generation signal 57N. In the following description, unless there is a particular need to distinguish between them, the first calculation signal 571P and the second calculation signal 572P will be collectively referred to as a calculation signal 57P.

As shown in FIG. 8 as an example, the phase difference α appears between the first calculation signal 571P and the second calculation signal 572P, which are output from the first phase-difference detection pixel 561P and the second phase-difference detection pixel 562P adjacent to each other in the X direction and the Y direction. The phase difference α is also referred to as parallax. With the phase difference α, it is possible to know a movement direction and a movement amount of the focus lens 26 for obtaining a focal position. The controller 32 derives the focal position of the focus lens 26 based on the phase difference α and performs autofocus control of automatically moving the focus lens 26 to the focal position. A first focal position FP1 is an example of “information related to the first focal position” according to the technology of the present disclosure.

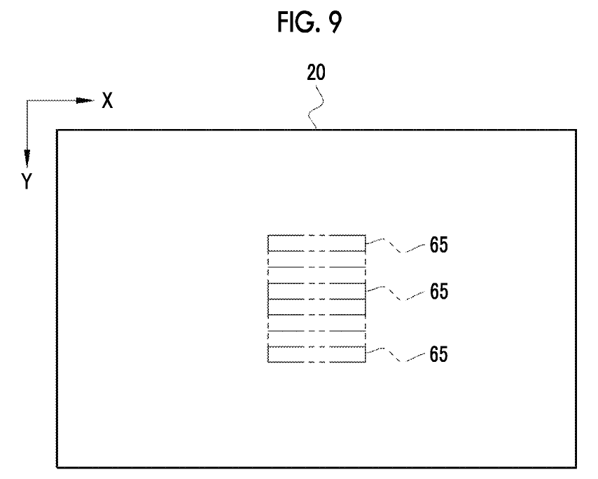

As shown in FIG. 9 as an example, a region (hereinafter, referred to as a focus adjustment region) 65 for deriving the first focal position FP1 is set in advance at a center portion of the imaging surface 20. The focus adjustment region 65 is a rectangular region that is long in the X direction. A plurality of the focus adjustment regions 65, eight in this example, are set.

The focus adjustment region 65 may be a region designated by the user, or a region surrounding a specific subject recognized by a known subject recognition technology. The specific subject is a pupil, a face, or a body of a person, a pupil, a face, or a body of an animal, or a head, a body, or the like of a vehicle such as an automobile, a railway vehicle, or an airplane. Here, the pupil of the person or the animal is a pupil, which is a so-called black eye. The face of the person or the animal is a portion having, for example, a forehead, a cheek, a chin, eyes, a nose, a mouth, and ears. The body of the person or the animal is a portion excluding a head, a neck, limbs, and a tail. The head of the vehicle is a front body in a case of the automobile, a portion of a head car having a destination display, a front window, a headlight, or the like in a case of the railway car, and a nose portion having a radome, front window, or the like in a case of the airplane. The body of the vehicle is the entire body excluding wheels in a case of the automobile, the entire body excluding wheels in a case of the railway car regardless of whether the car is a head car, an intermediate car, or a last car, and the entire body excluding a head, main wings, a tail, and the like in a case of the airplane. The focus adjustment region 65 may be the entire imaging surface 20.

The image generation signal 57N is used for generating a captured image such as a live view image as its name indicates. On the other hand, the calculation signal 57P is used only to derive the phase difference α and the first focal position FP1 and is not used to generate the captured image. Therefore, in the pixel interpolation processing, the image processing unit 42 interpolates a pixel value of the phase-difference detection pixel 56P by using the image generation signals 57N of the normal pixels 56N around the phase-difference detection pixel 56P.

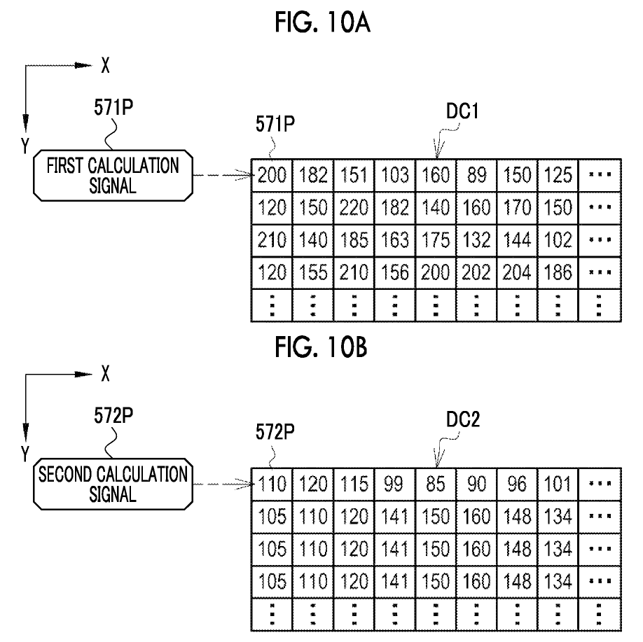

Here, specifically, the calculation signal 57P is divided into, for example, first calculation data DC1 shown in FIG. 10A and second calculation data DC2 shown in FIG. 10B. The first calculation data DC1 is data in which a plurality of first calculation signals 571P output from the first phase-difference detection pixel 561P are two-dimensionally arranged in the X direction and the Y direction in accordance with the arrangement of the first phase-difference detection pixels 561P. The second calculation data DC2 is data in which a plurality of second calculation signals 572P output from the second phase-difference detection pixel 562P are two-dimensionally arranged in the X direction and the Y direction in accordance with the arrangement of the second phase-difference detection pixels 562P. The first calculation data DC1 and the second calculation data DC2 can be treated as two-dimensional image data. In the following description, unless there is a particular need to distinguish between them, the first calculation data DC1 and the second calculation data DC2 will be collectively referred to as calculation data DC.

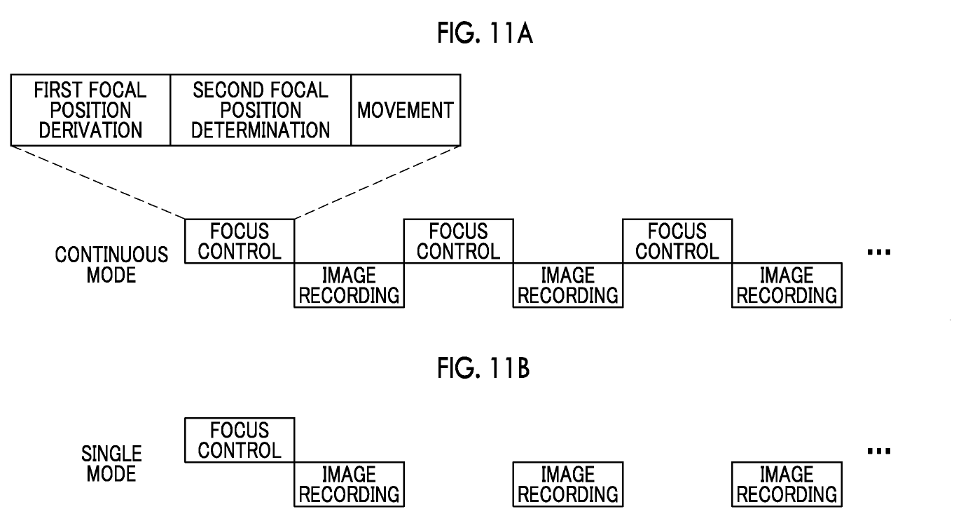

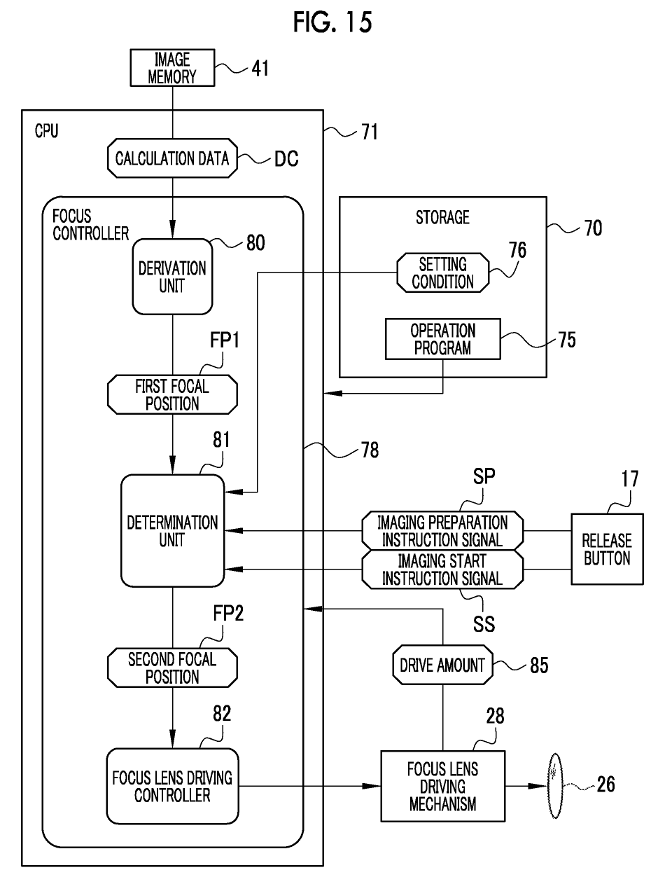

As shown in FIGS. 11A and 11B as an example, the continuous imaging mode includes a continuous mode shown in FIG. 11A and a single mode shown in FIG. 11B. The continuous mode is a mode in which focus control is performed each time before recording an image. The focus control includes derivation of the first focal position FP1 (see FIG. 15) using the calculation data DC, determination of a second focal position FP2 (see FIG. 15) using the first focal position FP1, and movement of the focus lens 26 to the second focal position FP2. Therefore, in the continuous mode, movement of the focus lens 26 to the second focal position FP2 determined in time series is continuously performed. The continuous mode is suitable for continuous imaging of a moving subject such as a running person, a flying bird, or a traveling railway vehicle.

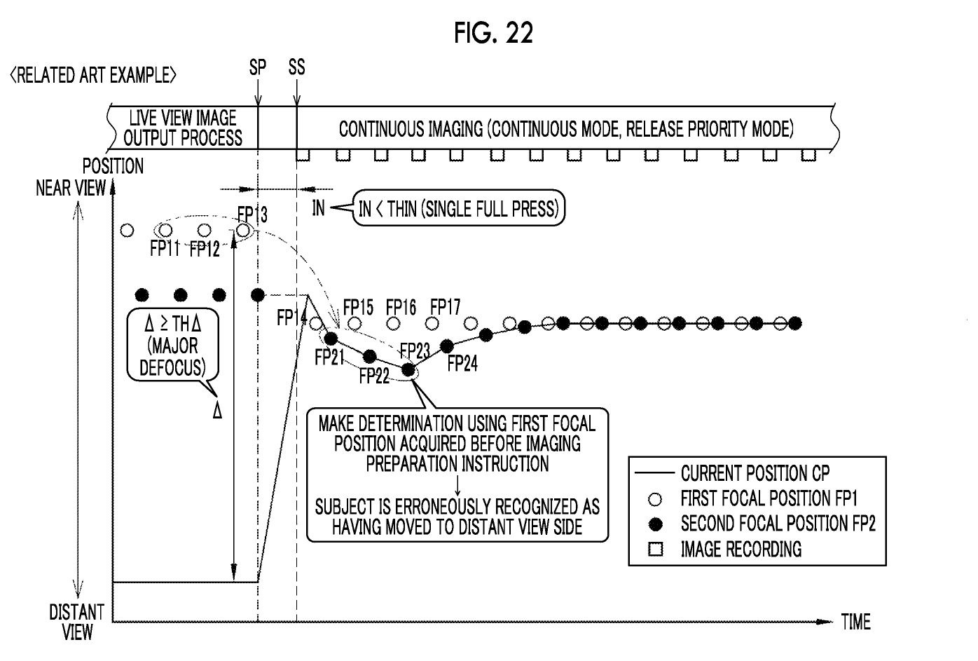

With respect to this, the single mode is a mode in which, in a case where a difference between a current position (hereinafter, referred to as a current position) CP (see FIG. 22) of the focus lens 26 and the second focal position FP2 is within an allowable range, the state is maintained. Therefore, in the single mode, the focus lens 26 is fixed at one second focal position FP2. The current position CP is an example of a “position of the focus lens” according to the technology of the present disclosure. The single mode is suitable for continuous imaging of a stationary subject, contrary to the continuous mode. The allowable range is set to a range in which a human eye can perceive an image to be in focus. The continuous mode and the single mode are selected by the user, for example, in the setting mode.

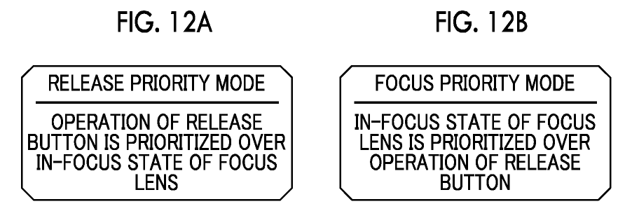

In addition, as shown in FIGS. 12A and 12B as an example, the continuous imaging mode includes a release priority mode shown in FIG. 12A and a focus priority mode shown in FIG. 12B. The release priority mode is a mode in which the operation of the release button 17 is prioritized over the in-focus state of the focus lens 26. Therefore, in the release priority mode, an image is recorded even in a state in which the difference between the current position CP of the focus lens 26 and the second focal position FP2 is outside the allowable range.

With respect to this, the focus priority mode is a mode in which the in-focus state of the focus lens 26 is prioritized over the operation of the release button 17, contrary to the release priority mode. Therefore, in the focus priority mode, an image is not recorded in a state in which the difference between the current position CP of the focus lens 26 and the second focal position FP2 is outside the allowable range. In the focus priority mode, image recording begins only in a state in which the difference between the current position CP of the focus lens 26 and the second focal position FP2 is within the allowable range. The release priority mode and the focus priority mode are also selected by the user, for example, in the setting mode.

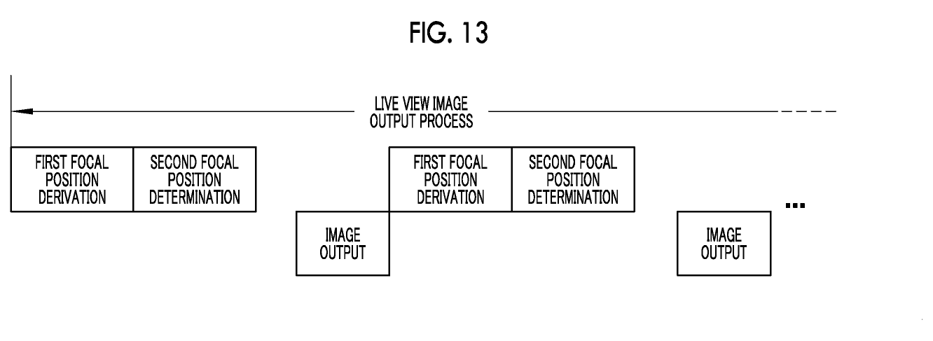

As shown in FIG. 13 as an example, in a state in which the release button 17 is not operated, the controller 32 performs a live view image output process of outputting a live view image of the subject. Specifically, the live view image output process is a process of reading in image data from the imaging element 19, performing various types of image processing on the image data, and outputting the image data after the various types of image processing as a live view image to the VRAM 44 at an interval corresponding to the display frame rate. In the live view image output process, the controller 32 performs the derivation of the first focal position FP1 and the determination of the second focal position FP2 in the focus control, but does not move the focus lens 26 to the second focal position FP2. For this reason, an out-of-focus live view image may be displayed on the liquid crystal monitor 15. In the focus control in the live view image output process, only the derivation of the first focal position FP1 may be performed.

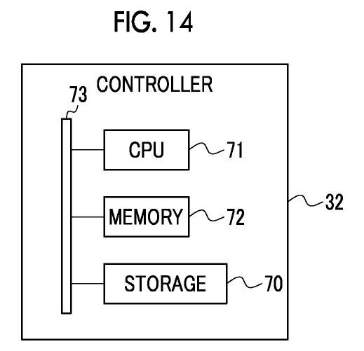

As shown in FIG. 14 as an example, the controller 32 comprises a storage 70, a central processing unit (CPU) 71, and a memory 72. The storage 70, the CPU 71, and the memory 72 are connected to each other via a busline 73. The controller 32 is an example of a “computer” according to the technology of the present disclosure.

The storage 70 is a non-volatile storage device such as an electrically erasable programmable read-only memory (EEPROM). The storage 70 stores various programs, various data associated with the various programs, and the like. Instead of the EEPROM, a ferroelectric random-access memory (FeRAM) or a magnetoresistive random-access memory (MRAM) may be used as the storage 70.

The memory 72 is a work memory for the CPU 71 to execute processing. The CPU 71 loads the program stored in the storage 70 into the memory 72 and executes processing corresponding to the program. As a result, the CPU 71 comprehensively controls the respective units of the imaging apparatus 10. The CPU 71 is an example of a “processor” according to the technology of the present disclosure. The memory 72 may be built in the CPU 71.

As shown in FIG. 15 as an example, an operation program 75 is stored in the storage 70. The operation program 75 is a program causing the CPU 71 to perform the autofocus control and the like. That is, the operation program 75 is an example of an “operation program of an imaging apparatus” according to the technology of the present disclosure. The storage 70 also stores a setting condition 76. The setting condition 76 is an example of a “preset condition” according to the technology of the present disclosure.

In a case where the operation program 75 is activated, the CPU 71 functions as a focus controller 78 in cooperation with the memory 72 and the like. The focus controller 78 includes a derivation unit 80, a determination unit 81, and a focus lens driving controller 82. The CPU 71 also functions as various processing units in addition to the focus controller 78.

The focus controller 78 receives the drive amount 85 of the focus motor from the focus lens driving mechanism 28. The focus controller 78 derives the current position CP of the focus lens 26 from the drive amount 85.

The derivation unit 80 reads out the calculation data DC from the image memory 41. The derivation unit 80 detects the phase difference α shown in FIG. 8 from the calculation data DC of the focus adjustment region 65. The derivation unit 80 derives the first focal position FP1 from the phase difference α. The derivation unit 80 outputs the derived first focal position FP1 to the determination unit 81.

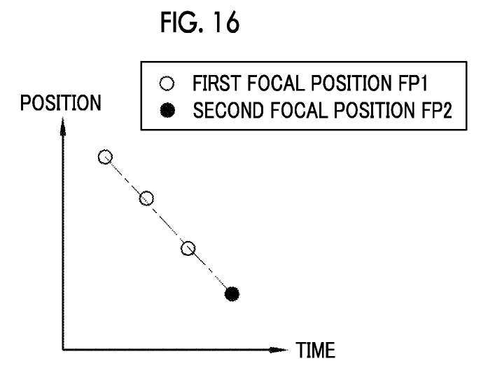

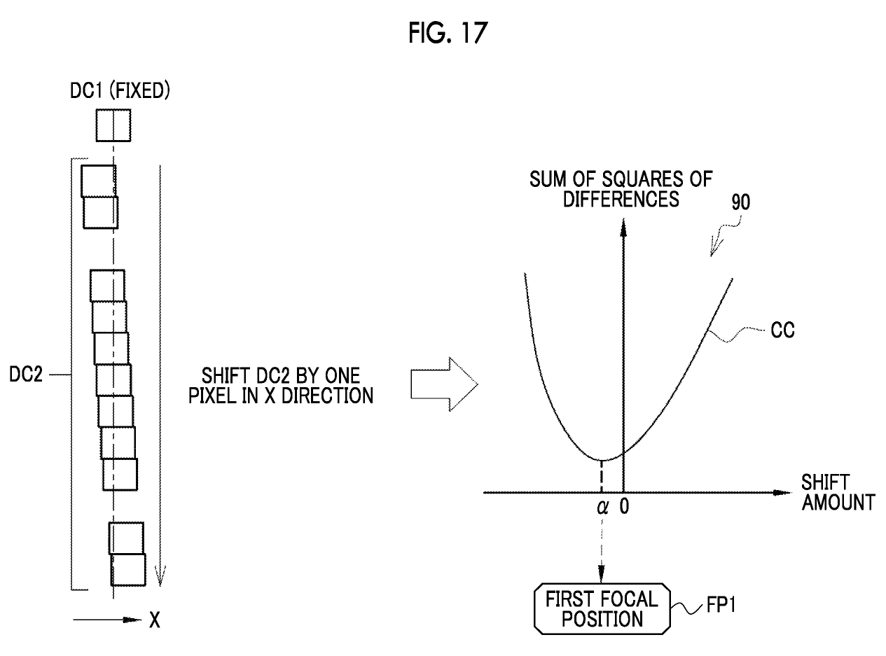

The determination unit 81 stores the first focal position FP1 derived by the derivation unit 80 in the past, which is the first focal position FP1 for a plurality of consecutive frames. As shown in FIG. 16 as an example, the determination unit 81 predicts a position of a subject that is considered to exist in, for example, the frame next to the current frame based on the first focal position FP1 derived in, for example, the frame two frames ago, the frame one frame ago, and the current frame. Then, the second focal position FP2 corresponding to the predicted position of the subject is determined. A one-dot chain line is a prediction curve corresponding to the first focal position FP1 derived in the frame two frames ago, the frame one frame ago, and the current frame. The first focal position FP1 derived in the frame two frames ago, the frame one frame ago, and the current frame is an example of “information related to the first focal position of the focus lens at the first time point” according to the technology of the present disclosure. In addition, the second focal position FP2 of the frame next to the current frame is an example of a “second focal position of the focus lens at the second time point after the first time point” according to the technology of the present disclosure. The determination unit 81 outputs the determined second focal position FP2 to the focus lens driving controller 82.

The setting condition 76 is input to the determination unit 81. In addition, the determination unit 81 receives an imaging preparation instruction signal SP and an imaging start instruction signal SS from the release button 17. The imaging preparation instruction signal SP is issued from the release button 17 in a case where the release button 17 is halfway press-operated. The imaging start instruction signal SS is issued from the release button 17 in a case where the release button 17 is fully press-operated.

The focus lens driving controller 82 controls the drive of the focus lens driving mechanism 28 and the focus lens 26. Specifically, the focus lens driving controller 82 moves the focus lens 26 from the current position CP to the second focal position FP2 determined by the determination unit 81 via the focus lens driving mechanism 28. Here, the phrase “the focus lens driving controller 82 moves the focus lens 26” strictly means that the focus lens driving controller 82 issues a drive signal to the driver of the focus motor of the focus lens driving mechanism 28, causing the focus motor to move the focus lens 26. In a case where the difference between the current position CP of the focus lens 26 and the second focal position FP2 is within the allowable range, the focus lens driving controller 82 does nothing as a matter of course, and the focus lens 26 is not moved.

As shown in FIG. 17 as an example, the derivation unit 80 fixes the first calculation data DC1 of the focus adjustment region 65 and shifts the second calculation data DC2 of the focus adjustment region 65 by one pixel in the X direction. Then, each time the second calculation data DC2 is shifted, a sum of squares of differences between the first calculation data DC1 and the second calculation data DC2 of the focus adjustment region 65 is calculated. Instead of the sum of squares of differences, a sum of absolute values of differences or normalized mutual correlation may be calculated.

In a graph 90, a horizontal axis represents the shift amount of the second calculation data DC2, and a vertical axis represents the sum of squares of differences. In the graph 90, a correlation curve CC is a line connecting plots of the sum of squares of differences at each shift amount. In the correlation curve CC, the shift amount at which the sum of squares of differences is minimized is the phase difference α.

The derivation unit 80 performs the above correlation calculation for each focus adjustment region 65. Therefore, a plurality of correlation curves CC for each focus adjustment region 65, in this example, eight correlation curves CC are obtained. The derivation unit 80 aggregates the plurality of correlation curves CC into one correlation curve CC by, for example, averaging the plurality of correlation curves CC. Then, the phase difference α is detected from the aggregated one correlation curve CC.

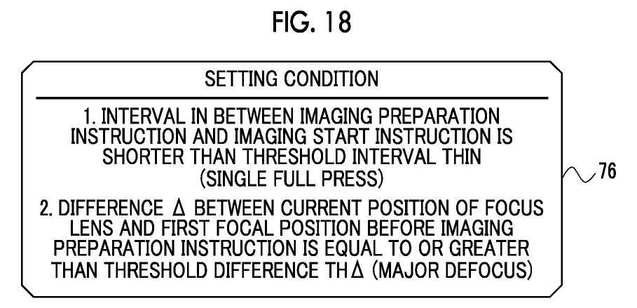

As shown in FIG. 18 as an example, the setting condition 76 includes the following first and second conditions.

1. An interval IN between the imaging preparation instruction and the imaging start instruction is shorter than a preset threshold interval THIN.

2. A difference Δ between the current position CP of the focus lens 26 and the first focal position FP1 before the imaging preparation instruction is equal to or greater than a preset threshold difference THΔ.

The interval IN between the imaging preparation instruction and the imaging start instruction in the first condition is an interval from the reception of the imaging preparation instruction signal SP to the reception of the imaging start instruction signal SS. In other words, the interval IN is an interval between the halfway-press operation and the full-press operation of the release button 17. Therefore, the first condition that the interval IN is shorter than the threshold interval THIN means that the interval between the halfway-press operation and the full-press operation of the release button 17 is extremely short. Hereinafter, the first condition that the interval IN is shorter than the threshold interval THIN will be referred to as a “single full press”.

The difference Δ between the current position CP of the focus lens 26 and the first focal position FP1 in the second condition is a so-called defocus amount. The larger the difference Δ is, the more out of focus the image is. Therefore, the second condition that the difference Δ is equal to or greater than the threshold difference THΔ means that the image is greatly out of focus. Hereinafter, the second condition that the difference Δ is equal to or greater than the threshold difference THΔ will be referred to as “major defocus”.

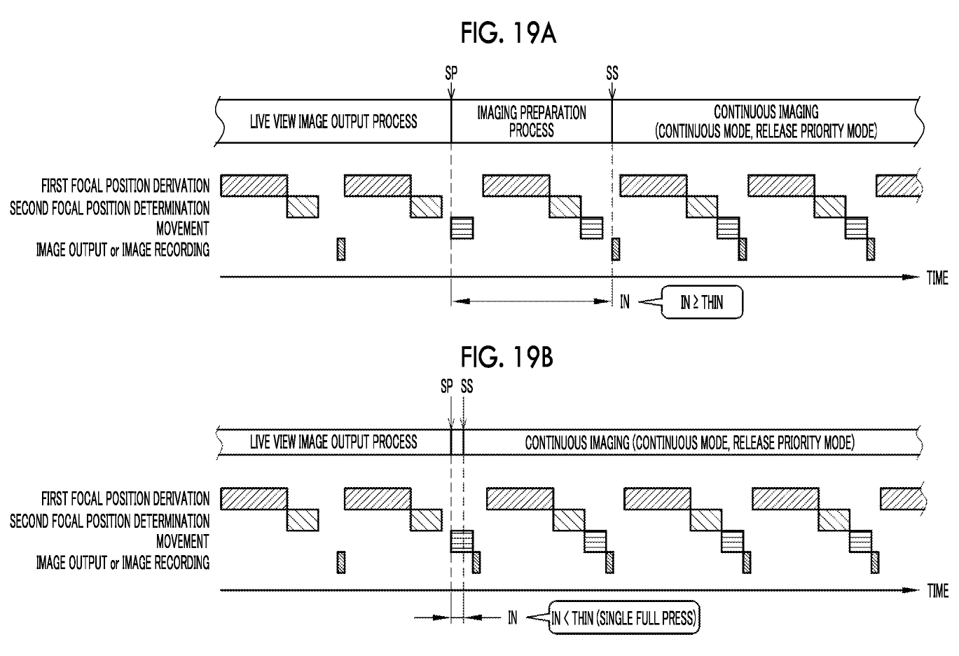

In FIGS. 19A and 19B, FIG. 22, and FIG. 23, processing for continuous imaging in the continuous mode and the release priority mode will be described.

As shown in FIG. 19A as an example, in a case where the interval IN between the imaging preparation instruction and the imaging start instruction is equal to or longer than the threshold interval THIN and there is no single full press, that is, in a case where the first condition of the setting condition 76 is not satisfied, sufficient time can be secured for an imaging preparation process after the reception of the imaging preparation instruction signal SP. The imaging preparation process begins with the movement of the focus lens 26 to the second focal position FP2 immediately after the reception of the imaging preparation instruction signal SP, and involves performing at least one focus control (derivation of the first focal position FP1, determination of the second focal position FP2, and movement of the focus lens 26 to the second focal position FP2). In this case, since the focus lens 26 is moved to the second focal position FP2 when receiving the imaging start instruction signal SS, recording of images in the continuous imaging starts immediately after the imaging start instruction signal SS is received.

On the other hand, as shown in FIG. 19B, in a case of the single full press in which the interval IN between the imaging preparation instruction and the imaging start instruction is shorter than the threshold interval THIN, that is, in a case where the first condition of the setting condition 76 is satisfied, sufficient time cannot be secured for the imaging preparation process. Therefore, the transition to the continuous imaging is made before the movement of the focus lens 26 to the second focal position FP2 immediately after the reception of the imaging preparation instruction signal SP is completed. That is, the movement of the focus lens 26 to the second focal position FP2 immediately after the reception of the imaging preparation instruction signal SP is involved in the continuous imaging. In this case, the focus lens 26 may be positioned far away from the second focal position FP2 when receiving the imaging start instruction signal SS. Therefore, images in the continuous imaging recorded immediately after the reception of the imaging start instruction signal SS may be out of focus.

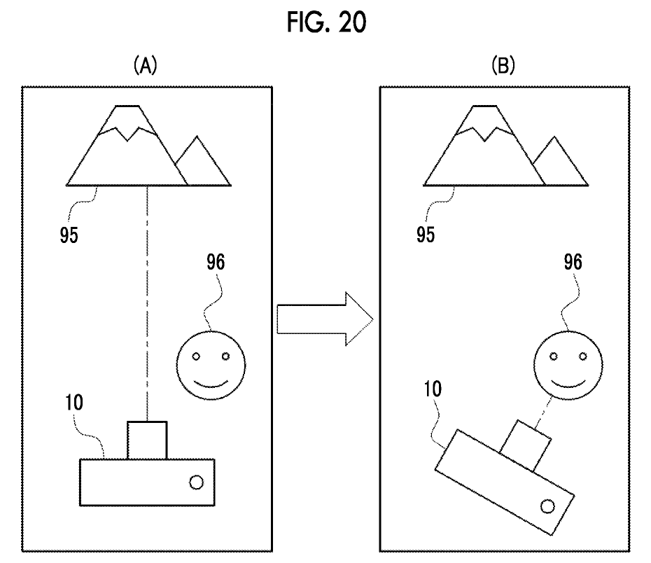

Here, a scene shown in FIG. 20 will be exemplified as a scene with major defocus. That is, (A) shows a state in which a mountain 95 in a distant view is in focus. In a case where the subject is switched from the mountain 95 in the distant view to a person 96 in a near view as shown in (B) from the state shown in (A), a distance between the imaging apparatus 10 and the subject is greatly varied. In a case where the distance between the imaging apparatus 10 and the subject is greatly varied, the difference Δ between the current position CP of the focus lens 26 and the first focal position FP1 is extremely large, resulting in major defocus. In a case of the major defocus, a waveform of the correlation curve CC obtained by performing the correlation calculation on the first calculation data DC1 and the second calculation data DC2 is distorted. Therefore, the accuracy of the phase difference α detected from the correlation curve CC and the accuracy of the derivation of the first focal position FP1 are reduced. Although a case where the switch is made from the distant view to the near view has been exemplified, the same applies to a case where the switch is made from the near view to the distant view.

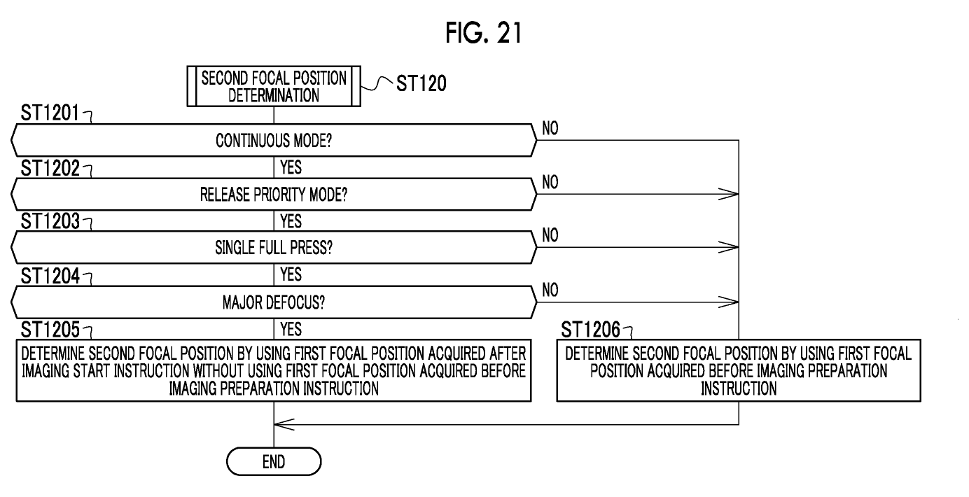

As shown in FIG. 21 as an example, in the continuous imaging, the determination unit 81 determines the second focal position FP2 as follows. That is, in a case where the continuous mode and the release priority mode are set (YES in steps ST1201 and ST1202), the single full press is met in which the interval IN between the imaging preparation instruction and the imaging start instruction is shorter than the threshold interval THIN (YES in step ST1203), and the major defocus is met in which the difference Δ between the current position CP of the focus lens 26 and the first focal position FP1 before the imaging preparation instruction is equal to or greater than the threshold difference THΔ (YES in step ST1204), the determination unit 81 determines the second focal position FP2 after the imaging start instruction by using the first focal position FP1 acquired after the imaging start instruction without using the first focal position FP1 acquired before the imaging preparation instruction (step ST1205).

On the other hand, in a case where the single mode is set (NO in step ST1201) and in a case where the focus priority mode is set (NO in step ST1202), the determination unit 81 determines the second focal position FP2 after the imaging start instruction by using the first focal position FP1 acquired before the imaging preparation instruction (step ST1206). In addition, in a case where the interval IN between the imaging preparation instruction and the imaging start instruction is equal to or longer than the threshold interval THIN and there is no single full press (NO in step ST1203) and in a case where the difference Δ between the current position CP of the focus lens 26 and the first focal position FP1 before the imaging preparation instruction is less than the threshold difference THΔ and there is no major defocus (NO in step ST1204), the determination unit 81 determines the second focal position FP2 after the imaging start instruction by using the first focal position FP1 acquired before the imaging preparation instruction (step ST1206).

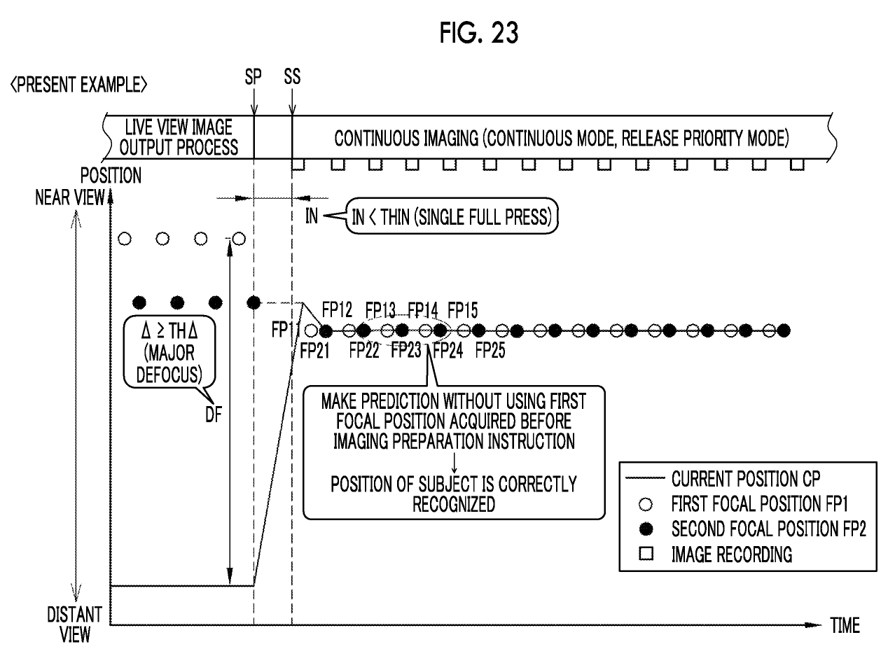

FIG. 22 is a diagram showing transitions of the first focal position FP1, the second focal position FP2, and the current position CP of the focus lens 26 in the related art example. In addition, FIG. 23 is a diagram showing transitions of the first focal position FP1, the second focal position FP2, and the current position CP of the focus lens 26 in the present example. Both FIG. 22 and FIG. 23 show a case where there are single full press and major defocus in the continuous imaging in the continuous mode and the release priority mode. Here, the difference Δ is a difference between the current position CP of the focus lens 26 and the first focal position FP1 in the live view image output process immediately before the imaging preparation instruction is issued.

In FIGS. 22 and 23, the operation is the same until, immediately after receiving the imaging preparation instruction signal SP, the focus lens 26 is moved to the second focal position FP2 determined immediately before receiving the imaging preparation instruction signal SP. Thereafter, in FIG. 22 of the related art example, the determination unit 81 determines the second focal position FP2 for several frames after the imaging start instruction by using not only the first focal position FP1 acquired after the imaging start instruction but also the first focal position FP1 acquired before the imaging preparation instruction. Specifically, the determination unit 81 determines the second focal position FP21 immediately after the imaging start instruction by using the first focal positions FP11, FP12, and FP13 acquired before the imaging preparation instruction and the first focal position FP14 acquired after the imaging start instruction. In addition, the determination unit 81 determines the second focal position FP22 by using the first focal positions FP12 and FP13 acquired before the imaging preparation instruction and the first focal positions FP14 and FP15 acquired after the imaging start instruction. Further, the determination unit 81 determines the second focal position FP23 by using the first focal position FP13 acquired before the imaging preparation instruction and the first focal positions FP14, FP15, and FP16 acquired after the imaging start instruction. In addition, the second focal position FP24 of the next frame is determined by the determination unit 81 by using the first focal positions FP14, FP15, FP16, and FP17 acquired after the imaging start instruction.

The first focal position FP1 changes from the first focal positions FP11, FP12, and FP13 on the near view side to the first focal position FP14 on the distant view side. This is because, as the focus lens 26 is moved to the second focal position FP2, the accuracy of deriving the first focal position FP1 is improved, and thus the original first focal position FP1 on the distant view side is derived. Therefore, based on the first focal positions FP11, FP12, and FP13 acquired before the imaging preparation instruction and the first focal position FP14 acquired after the imaging start instruction, the subject is erroneously recognized as having moved from the near view side to the distant view side. As a result, the second focal position FP21 is shifted to the distant view side relative to the corresponding first focal position FP14. For the same reason, the second focal positions FP22 and FP23 are shifted to the distant view side relative to the corresponding first focal positions FP15 and FP16. Images recorded by moving the focus lens 26 to these shifted second focal positions FP21, FP22, and FP23 become out-of-focus images.

On the other hand, in FIG. 23 of the present example, for the first frame after the image is recorded immediately after the imaging start instruction, the determination unit 81 determines the second focal position FP21 based on the first focal position FP11 acquired immediately after the image is recorded. In addition, for the next several frames, the determination unit 81 determines the second focal position FP2 by using only the first focal position FP1 acquired after the imaging start instruction without using the first focal position FP1 acquired before the imaging preparation instruction. Specifically, the determination unit 81 determines the second focal position FP22 by using the first focal positions FP11 and FP12 acquired after the imaging start instruction. In addition, the determination unit 81 determines the second focal position FP23 by using the first focal positions FP11, FP12, and FP13 acquired after the imaging start instruction. The determination unit 81 determines the second focal position FP24 by using the first focal positions FP11, FP12, FP13, and FP14 acquired after the imaging start instruction. In addition, the second focal position FP25 of the next frame is determined by the determination unit 81 by using the first focal positions FP12, FP13, FP14, and FP15 acquired after the imaging start instruction. In the present example, the second focal position FP2 is determined by using the first focal position FP1 acquired after the imaging start instruction, but the present invention is not limited to this. The second focal position FP2 may also be determined by using the first focal position FP1 (the first focal position FP1 acquired between the imaging preparation instruction and the imaging start instruction) acquired after the imaging preparation instruction.

Time points at which the first focal positions FP11, FP12, FP13, FP14, and FP15 are acquired are each an example of a “first time point” according to the technology of the present disclosure. In addition, time points at which the second focal positions FP21, FP22, FP23, FP24, and FP25 are determined are each an example of a “second time point” according to the technology of the present disclosure. As described above, the first time point related to the first focal position FP1 and the second time point related to the second focal position FP2 in a case where the imaging preparation instruction is received and the setting condition 76 is satisfied are after the imaging preparation instruction.

In the present example, the first focal position FP1 acquired before the imaging preparation instruction is not used for determining the second focal position FP2 after the imaging start instruction. Therefore, unlike the related art example, the subject is not erroneously recognized as having moved from the near view side to the distant view side, and the position of the subject can be correctly recognized. As a result, the second focal positions FP22, FP23, and FP24 substantially match the corresponding first focal positions FP12, FP13, and FP14. Images recorded by moving the focus lens 26 to these second focal positions FP22, FP23, and FP24 become in-focus images.

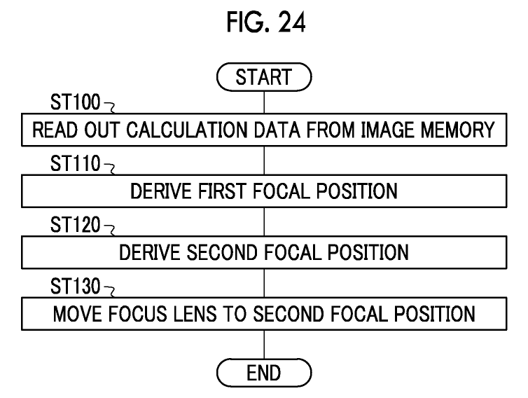

Next, an operation of the above configuration will be described with reference to a flowchart shown in FIG. 24 as an example. As shown in FIG. 15, the CPU 71 of the controller 32 functions as the focus controller 78 as the operation program 75 is activated. The focus controller 78 includes the derivation unit 80, the determination unit 81, and the focus lens driving controller 82.

In the still image capturing mode, in a case where the user halfway press-operates the release button 17 and then continues to fully press-operates it for a predetermined time or longer, the continuous imaging mode is activated. Under the control of the controller 32, the imaging element 19 performs an accumulation operation of signal charges corresponding to the subject light. Subsequently, the readout operation of the image signals 57 corresponding to the signal charges is performed. The image signals 57 are stored in the image memory 41 via the image input controller 40. The image signals 57 are subjected to various types of image processing by the image processing unit 42 and then written back to the image memory 41.

In the focus controller 78, the calculation data DC is read out from the image memory 41 to the derivation unit 80 (step ST100). Then, as shown in FIG. 17, the derivation unit 80 detects the phase difference α from the calculation data DC of the focus adjustment region 65, and derives the first focal position FP1 from the phase difference α (step ST110). The first focal position FP1 is output from the derivation unit 80 to the determination unit 81. In addition, the focus controller 78 derives the current position CP of the focus lens 26 based on the drive amount 85 of the focus motor from the focus lens driving mechanism 28.

As shown in FIG. 21, the determination unit 81 determines the second focal position FP2 by using the first focal position FP1 (step ST120). Specifically, in a case where the continuous mode and the release priority mode are set, the single full press is met in which the interval IN between the imaging preparation instruction and the imaging start instruction is shorter than the threshold interval THIN, and the major defocus is met in which the difference Δ between the current position CP of the focus lens 26 and the first focal position FP1 before the imaging preparation instruction is equal to or greater than the threshold difference THΔ, the determination unit 81 determines the second focal position FP2 after the imaging start instruction by using the first focal position FP1 acquired after the imaging start instruction without using the first focal position FP1 acquired before the imaging preparation instruction. On the other hand, in a case where the single mode is set, in a case where the focus priority mode is set, in a case where the interval IN between the imaging preparation instruction and the imaging start instruction is equal to or longer than the threshold interval THIN and there is no single full press, and in a case where the difference Δ between the current position CP of the focus lens 26 and the first focal position FP1 before the imaging preparation instruction is less than the threshold difference THΔ and there is no major defocus, the determination unit 81 determines the second focal position FP2 after the imaging start instruction by using the first focal position FP1 acquired before the imaging preparation instruction. The second focal position FP2 is output from the determination unit 81 to the focus lens driving controller 82.

The focus lens 26 is moved to the second focal position FP2 under the control of the focus lens driving controller 82 (step ST130).

As described above, the imaging apparatus 10 comprises the determination unit 81. The determination unit 81 determines, using the first focal position FP1 of the focus lens 26 at the first time point, the second focal position FP2 of the focus lens 26 at the second time point after the first time point in the continuous imaging. In a case where the imaging preparation instruction is received and the setting condition 76 is satisfied, the determination unit 81 determines the second focal position FP2 using the first focal position FP1 acquired after the imaging preparation instruction. Therefore, the reliability of the second focal position FP2 of the focus lens 26 determined in the continuous imaging can be improved.

As shown in FIG. 23, the first time point and the second time point in a case where the imaging preparation instruction is received and the setting condition 76 is satisfied are after the imaging start instruction. Therefore, the erroneous recognition of the position of the subject due to the first focal position FP1 acquired before the imaging preparation instruction can be prevented, and the position of the subject can be correctly recognized. As a result, an in-focus image can always be acquired in the continuous imaging.

In addition, as shown in FIG. 23, in a case where the imaging preparation instruction is received and the setting condition 76 is satisfied, the determination unit 81 determines the second focal position FP2 without using the first focal position FP1 acquired before the imaging preparation instruction. Since the first focal position FP1 acquired before the imaging preparation instruction is not used, which has relatively low derivation accuracy, the prediction accuracy of the second focal position FP2 can be improved. The erroneous recognition of the position of the subject due to the first focal position FP1 acquired before the imaging preparation instruction can be prevented, and the position of the subject can be correctly recognized. As a result, an in-focus image can always be acquired in the continuous imaging.

As shown in FIG. 18, the setting condition 76 is that the interval IN between the imaging preparation instruction and the imaging start instruction is shorter than the preset threshold interval THIN. In addition, the setting condition 76 is that the difference Δ between the current position CP of the focus lens 26 and the first focal position FP1 before the imaging preparation instruction is equal to or greater than the preset threshold difference THΔ. Therefore, it is possible to prevent the erroneous recognition of the position of the subject that occurs in a case of the single full press in which the interval IN is shorter than the threshold interval THIN and the major defocus in which the difference Δ is equal to or greater than the threshold difference THΔ.

As shown in FIG. 13, the controller 32 performs a live view image output process of outputting a live view image of the subject, in which at least the first focal position FP1 is derived, but the focus lens 26 is not moved to the second focal position FP2. As shown in FIG. 23, the difference Δ is a difference between the current position CP of the focus lens 26 and the first focal position FP1 in the live view image output process immediately before the imaging preparation instruction is issued. Therefore, it is possible to determine whether or not the first focal position FP1 immediately before the imaging preparation instruction related to the determination of the second focal position FP2 is derived in the major defocus state.

As shown in FIG. 21, in a case where the interval IN between the imaging preparation instruction and the imaging start instruction is equal to or longer than the preset threshold interval THIN, the determination unit 81 determines the second focal position FP2 by using the first focal position FP1 acquired before the imaging preparation instruction. In a case where the interval IN is equal to or longer than the threshold interval THIN and there is no single full press, as shown in FIG. 19A, sufficient time can be secured for the imaging preparation process, and the subject can be brought into focus before the imaging start instruction. Therefore, even in a case where the second focal position FP2 is determined by using the first focal position FP1 acquired before the imaging preparation instruction, the erroneous recognition of the position of the subject due to the first focal position FP1 acquired before the imaging preparation instruction does not occur.

In addition, as shown in FIG. 21, in a case where the difference Δ between the current position CP of the focus lens 26 and the first focal position FP1 before the imaging preparation instruction is less than the preset threshold difference THΔ, the determination unit 81 determines the second focal position FP2 by using the first focal position FP1 acquired before the imaging preparation instruction. In a case where the difference Δ is less than the threshold difference THΔ and there is no major defocus, the accuracy of deriving the first focal position FP1 acquired before the imaging preparation instruction is relatively high. Therefore, even in a case where the second focal position FP2 is determined by using the first focal position FP1 acquired before the imaging preparation instruction, the erroneous recognition of the position of the subject due to the first focal position FP1 acquired before the imaging preparation instruction does not occur.

As shown in FIGS. 11A and 11B, the continuous imaging includes a continuous mode in which the movement of the focus lens 26 to the second focal position FP2 output in time series is continuously performed, and a single mode in which the focus lens 26 is fixed at one second focal position FP2. As shown in FIG. 21, in a case where the continuous mode is set and the setting condition 76 is satisfied, the determination unit 81 determines the second focal position FP2 by using the first focal position FP1 acquired after the imaging start instruction without using the first focal position FP1 acquired before the imaging preparation instruction. On the other hand, in a case where the single mode is set, the determination unit 81 determines the second focal position FP2 using the first focal position FP1 acquired before the imaging preparation instruction. In a case of the single mode, the focus lens 26 is moved to a certain second focal position FP2 and maintained in that state, so that there is no problem in determining the second focal position FP2 by using the first focal position FP1 acquired before the imaging preparation instruction.

As shown in FIGS. 12A and 12B, the continuous imaging includes a release priority mode in which the operation of the release button 17 is prioritized over the in-focus state of the focus lens 26, and a focus priority mode in which the in-focus state of the focus lens 26 is prioritized over the operation of the release button 17. As shown in FIG. 21, in a case where the release priority mode is set and the setting condition 76 is satisfied, the determination unit 81 determines the second focal position FP2 by using the first focal position FP1 acquired after the imaging start instruction without using the first focal position FP1 acquired before the imaging preparation instruction. On the other hand, in a case where the focus priority mode is set, the determination unit 81 determines the second focal position FP2 using the first focal position FP1 acquired before the imaging preparation instruction. In a case of the focus priority mode, the continuous imaging is started after focusing, so that there is no problem in determining the second focal position FP2 by using the first focal position FP1 acquired before the imaging preparation instruction.

As shown in FIG. 15, the imaging preparation instruction is an instruction corresponding to the halfway-press operation of the release button 17, and the imaging start instruction is an instruction corresponding to the full-press operation of the release button 17. Therefore, the imaging preparation instruction and the imaging start instruction can be easily performed.

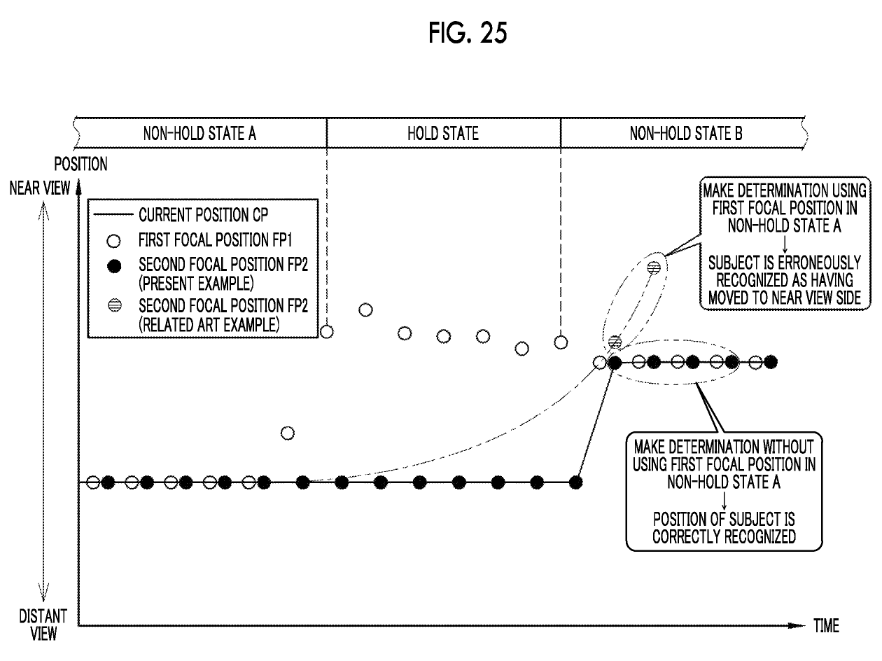

As shown in FIG. 25 as an example, a case where the imaging apparatus 10 has a hold function for the second focal position FP2 is considered. The hold function regards a sudden change in the first focal position FP1 as a derivation error, and holds the second focal position FP2 at a value before the change in the first focal position FP1. Then, in a case where it is determined that the change in the first focal position FP1 has settled, the hold on the second focal position FP2 is released. In this case, there is a high probability that the position of the subject is changed between the non-hold state A before the hold state and the non-hold state B after transition from the hold state. Therefore, in a case where the second focal position FP2 is determined in the non-hold state B by using the first focal position FP1 acquired in the non-hold state A, there is a risk that the position of the subject may be erroneously recognized as shown in a prediction curve indicated by a one-dot chain line, as in the case shown in FIG. 22.

Therefore, in the non-hold state B, the second focal position FP2 is determined without using the first focal position FP1 acquired in the non-hold state A. In this way, it is possible to prevent the erroneous recognition of the position of the subject and to correctly recognize the position of the subject. As a result, it is possible to acquire an in-focus image even in the non-hold state B after transition from the hold state.

Instead of the first focal position FP1, the difference Δ from the current position CP of the focus lens 26 may be derived as information related to the first focal position FP1.

In the live view image output process, the system may be configured to be switchable between a mode in which at least the first focal position FP1 is derived but the focus lens 26 is not moved to the second focal position FP2, and a mode in which the first focal position FP1 is derived, the second focal position FP2 is determined, and the focus lens 26 is moved to the second focal position FP2. Even in the latter mode, in a case where the release button 17 is halfway-pressed immediately after the distance between the imaging apparatus 10 and the subject is greatly changed, the difference Δ between the current position CP of the focus lens 26 and the first focal position FP1 may be equal to or greater than the threshold difference THΔ. Therefore, the technology of the present disclosure can also be applied to the latter mode.

The imaging apparatus according to the technology of the present disclosure is not limited to the exemplified digital camera, and may also be a video camera, a surveillance camera, a smartphone, or a tablet terminal.

In the embodiment described above, for example, each process of processing units such as the image processing unit 42, the display controller 45, the instruction receiving unit 47, the focus controller 78, the derivation unit 80, the determination unit 81, and the focus lens driving controller 82 is executed by any computer. In addition, any computer may execute these processes using a processor as hardware, a program as software, or a combination thereof. In that case, the processor is configured to execute various processes in the above embodiment in cooperation with the program, and can function as each unit or each means in the above embodiment. In addition, the order in which the processes are executed by the processor is not limited to the order described above and may be changed as appropriate. Any computer may be a general-purpose computer, a computer for a specific use, a workstation, or another system capable of executing each process.

The processor may be configured by one or more pieces of hardware, and the type of hardware is not limited. For example, the processor may be configured by a programmable logic device such as the exemplified CPU 71, a micro processing unit (MPU), or a field programmable gate array (FPGA), a dedicated circuit for executing specific processing such as an application specific integrated circuit (ASIC), or hardware such as a graphics processing unit (GPU) or a neural processing unit (NPU). In addition, the types of hardware may be a combination of different types of hardware. In a case where a plurality of pieces of hardware are configured to execute one or a plurality of processes of a certain processor, the plurality of pieces of hardware may be present in devices physically separated from each other, or may be present in the same device. In addition, in any of the embodiments, the order of each processing executed by the processor is not limited to the above order and may be changed as appropriate. The hardware is configured by an electric circuit (circuitry) in which circuit elements such as semiconductor elements are combined.

Further, the program may be software such as firmware or a microcode. In addition, the program may be, for example, a program module group, and each function thereof may be realized by a processor configured to execute each function. The program may be a program code or a plurality of code segments stored in one or a plurality of non-transitory computer-readable media (for example, a storage medium or other storage). The program may be divided and stored in a plurality of non-transitory computer-readable media present in devices physically separated from each other. The program code or the code segment may represent any combination of a procedure, a function, a subprogram, a routine, a subroutine, a module, a software package, a class, an instruction, a data structure, or a program statement. The program code or the code segment may be connected to another code segment or a hardware circuit by transmitting and receiving information, data, an argument, a parameter, or memory contents.

It is possible to understand the technologies described in the following supplementary notes from the above description.

### Supplementary Note 1

An imaging apparatus that determines, using information related to a first focal position of a focus lens at a first time point, a second focal position of the focus lens at a second time point after the first time point in continuous imaging, the imaging apparatus comprising:

a processor,

in which the processor is configured to, in a case where a first imaging instruction is received and a preset condition is satisfied, determine the second focal position using the information related to the first focal position acquired after the first imaging instruction.

### Supplementary Note 2

The imaging apparatus according to Supplementary Note 1,

in which the first time point and the second time point in a case where the first imaging instruction is received and the condition is satisfied are after the first imaging instruction.

### Supplementary Note 3

The imaging apparatus according to Supplementary Note 2,

in which the processor is configured to, in a case where the first imaging instruction is received and the condition is satisfied, determine the second focal position without using the information related to the first focal position acquired before the first imaging instruction.

### Supplementary Note 4

The imaging apparatus according to any one of Supplementary Notes 1 to 3,

in which the condition is that an interval between the first imaging instruction and a second imaging instruction given after the first imaging instruction is shorter than a preset threshold interval.

### Supplementary Note 5

The imaging apparatus according to any one of Supplementary Notes 1 to 4,

in which the condition is that a difference between a position of the focus lens and the first focal position before the first imaging instruction is equal to or greater than a preset threshold difference.

### Supplementary Note 6

The imaging apparatus according to Supplementary Note 5,

in which the processor is configured to perform a live view image output process of outputting a live view image of a subject, in which information related to at least the first focal position is derived but the focus lens is not moved to the second focal position, and

the difference is a difference between the position of the focus lens and the first focal position in the live view image output process immediately before the first imaging instruction is issued.

### Supplementary Note 7

The imaging apparatus according to any one of Supplementary Notes 1 to 6,

in which the processor is configured to, in a case where an interval between the first imaging instruction and a second imaging instruction given after the first imaging instruction is equal to or longer than a preset threshold interval, determine the second focal position using the information related to the first focal position acquired before the first imaging instruction.

### Supplementary Note 8

The imaging apparatus according to any one of Supplementary Notes 1 to 6,

in which the processor is configured to, in a case where a difference between a position of the focus lens and the first focal position before the first imaging instruction is less than a preset threshold difference, determine the second focal position using the information related to the first focal position acquired before the first imaging instruction.

### Supplementary Note 9

The imaging apparatus according to any one of Supplementary Notes 1 to 6,

in which the processor is configured to, in a case where an interval between the first imaging instruction and a second imaging instruction given after the first imaging instruction is equal to or longer than a preset threshold interval and in a case where a difference between a position of the focus lens and the first focal position before the first imaging instruction is less than a preset threshold difference, determine the second focal position using the information related to the first focal position acquired before the first imaging instruction.

### Supplementary Note 10

The imaging apparatus according to any one of Supplementary Notes 1 to 9,

in which the continuous imaging includes a continuous mode in which movement of the focus lens to the second focal position output in time series is continuously performed, and a single mode in which the focus lens is fixed at one second focal position, and

the processor is configured to

in a case where the condition is satisfied in the continuous mode, determine the second focal position using the information related to the first focal position acquired after a second imaging instruction given after the first imaging instruction without using the information related to the first focal position acquired before the first imaging instruction, and

in a case of the single mode, determine the second focal position using the information related to the first focal position acquired before the first imaging instruction.

### Supplementary Note 11

The imaging apparatus according to any one of Supplementary Notes 1 to 10,

in which the continuous imaging includes a release priority mode in which an operation of a release button is prioritized over an in-focus state of the focus lens, and a focus priority mode in which the in-focus state of the focus lens is prioritized over the operation of the release button, and

the processor is configured to

in a case where the condition is satisfied in the release priority mode, determine the second focal position using the information related to the first focal position acquired after a second imaging instruction given after the first imaging instruction without using the information related to the first focal position acquired before the first imaging instruction, and

in a case of the focus priority mode, determine the second focal position using the information related to the first focal position acquired before the first imaging instruction.

### Supplementary Note 12

The imaging apparatus according to any one of Supplementary Notes 1 to 11,

in which the first imaging instruction is an instruction in response to a halfway-press operation of a release button, and

a second imaging instruction given after the first imaging instruction is an instruction in response to a full-press operation of the release button.

In the technology of the present disclosure, the above-described various embodiments and/or various modification examples may be combined with each other as appropriate. In addition, the present disclosure is not limited to the above-described embodiments, and various configurations can be adopted without departing from the gist of the present disclosure. Furthermore, the technology of the present disclosure extends to a storage medium that non-transitorily stores the program, and a computer program product including the program, in addition to the program.

The above descriptions and illustrations are detailed descriptions of portions related to the technology of the present disclosure and are merely examples of the technology of the present disclosure. For example, description related to the above configurations, functions, actions, and effects is description related to an example of configurations, functions, actions, and effects of the parts according to the technology of the present disclosure. Thus, it goes without saying that unnecessary portions may be deleted, new elements may be added, or replacement may be made to the content of the above description and the content of the drawings without departing from the gist of the technique of the present disclosure. Further, in order to avoid complications and facilitate understanding of the parts related to the technology of the present disclosure, descriptions of common general knowledge and the like that do not require special descriptions for enabling the implementation of the technology of the present disclosure are omitted, in the contents described and shown above.

In the present specification, the term “A and/or B” is synonymous with the term “at least one of A or B”. That is, the term “A and/or B” means only A, only B, or a combination of A and B. In addition, in the present specification, the same approach as “A and/or B” is applied to a case in which three or more matters are represented by connecting the matters with “and/or”.

All documents, patent applications, and technical standards mentioned in this specification are incorporated herein by reference to the same extent as in a case where each document, each patent application, and each technical standard are specifically and individually described by being incorporated by reference.

What is claimed is:

1. An imaging apparatus that determines, using information related to a first focal position of a focus lens at a first time point, a second focal position of the focus lens at a second time point after the first time point, the imaging apparatus comprising:
a processor,
wherein the processor is configured to, in a case where a first imaging instruction is received and a preset condition is satisfied, determine the second focal position using the information related to the first focal position acquired after the first imaging instruction.

2. The imaging apparatus according to claim 1,
wherein the first time point and the second time point in a case where the first imaging instruction is received and the condition is satisfied are after the first imaging instruction.

3. The imaging apparatus according to claim 2,
wherein the processor is configured to, in a case where the first imaging instruction is received and the condition is satisfied, determine the second focal position without using the information related to the first focal position acquired before the first imaging instruction.

4. The imaging apparatus according to claim 1,
wherein the condition is that an interval between the first imaging instruction and a second imaging instruction given after the first imaging instruction is shorter than a preset threshold interval.

5. The imaging apparatus according to claim 1,
wherein the condition is that a difference between a position of the focus lens and the first focal position before the first imaging instruction is equal to or greater than a preset threshold difference.

6. The imaging apparatus according to claim 5,
wherein the processor is configured to perform a live view image output process of outputting a live view image of a subject, in which information related to at least the first focal position is derived but the focus lens is not moved to the second focal position, and
the difference is a difference between the position of the focus lens and the first focal position in the live view image output process immediately before the first imaging instruction is issued.

7. The imaging apparatus according to claim 1,
wherein the processor is configured to, in a case where an interval between the first imaging instruction and a second imaging instruction given after the first imaging instruction is equal to or longer than a preset threshold interval, determine the second focal position using the information related to the first focal position acquired before the first imaging instruction.

8. The imaging apparatus according to claim 1,
wherein the processor is configured to, in a case where a difference between a position of the focus lens and the first focal position before the first imaging instruction is less than a preset threshold difference, determine the second focal position using the information related to the first focal position acquired before the first imaging instruction.

9. The imaging apparatus according to claim 1,
wherein the processor is configured to, in a case where an interval between the first imaging instruction and a second imaging instruction given after the first imaging instruction is equal to or longer than a preset threshold interval and in a case where a difference between a position of the focus lens and the first focal position before the first imaging instruction is less than a preset threshold difference, determine the second focal position using the information related to the first focal position acquired before the first imaging instruction.

10. The imaging apparatus according to claim 1,
wherein continuous imaging is performed, and the continuous imaging includes a continuous mode in which movement of the focus lens to the second focal position output in time series is continuously performed, and a single mode in which the focus lens is fixed at one second focal position, and
the processor is configured to
in a case where the condition is satisfied in the continuous mode, determine the second focal position using the information related to the first focal position acquired after a second imaging instruction given after the first imaging instruction without using the information related to the first focal position acquired before the first imaging instruction, and
in a case of the single mode, determine the second focal position using the information related to the first focal position acquired before the first imaging instruction.

11. The imaging apparatus according to claim 1,
wherein continuous imaging is performed, and the continuous imaging includes a release priority mode in which an operation of a release button is prioritized over an in-focus state of the focus lens, and a focus priority mode in which the in-focus state of the focus lens is prioritized over the operation of the release button, and
the processor is configured to
in a case where the condition is satisfied in the release priority mode, determine the second focal position using the information related to the first focal position acquired after a second imaging instruction given after the first imaging instruction without using the information related to the first focal position acquired before the first imaging instruction, and
in a case of the focus priority mode, determine the second focal position using the information related to the first focal position acquired before the first imaging instruction.

12. The imaging apparatus according to claim 1,
wherein the first imaging instruction is an instruction in response to a halfway-press operation of a release button, and
a second imaging instruction given after the first imaging instruction is an instruction in response to a full-press operation of the release button.

13. An operation method of an imaging apparatus that determines, using information related to a first focal position of a focus lens at a first time point, a second focal position of the focus lens at a second time point after the first time point, the operation method comprising:
determining the second focal position using the information related to the first focal position acquired after a first imaging instruction, in a case where the first imaging instruction is received and a preset condition is satisfied.

14. A non-transitory computer-readable storage medium storing an operation program of an imaging apparatus that determines, using information related to a first focal position of a focus lens at a first time point, a second focal position of the focus lens at a second time point after the first time point, the operation program causing a computer to execute a process comprising:
determining the second focal position using the information related to the first focal position acquired after a first imaging instruction, in a case where the first imaging instruction is received and a preset condition is satisfied.
